(19) United States
(12) Patent Application Publication
(10) Pub. No.: US 2026/0351872 A1
(43) Pub. Date: Nov. 5, 2026

(54) TERMINAL BLOCK

(71) Applicant: Yazaki Corporation, Tokyo (JP)

(72) Inventors: Michihiro MORI, Shizuoka (JP); Yoshihiro IWAHORI, Shizuoka (JP)

(73) Assignee: Yazaki Corporation, Tokyo (JP)

(21) Appl. No.: 19/468,575

(22) Filed: Feb. 3, 2026

(30) Foreign Application Priority Data
Feb. 12, 2025 (JP) 2025-020534

(51) Int. Cl. H01R 9/24

(52) U.S. Cl. CPC H01R 9/2425; H01R 2201/26

(57) ABSTRACT

A terminal block includes a bus bar, a magnetic body unit including an annular magnetic body and a cover covering the magnetic body, the magnetic body unit being configured such that the bus bar can be inserted into the magnetic body; a packing mounted on the bus bar inserted into the magnetic body unit; and a housing including a through hole that holds the bus bar and the packing, and a cylindrical portion that accommodates the magnetic body unit, in which the cover includes a support portion that supports the packing inserted into the through hole.

### CROSS-REFERENCE TO RELATED APPLICATION(S)

The present application claims priority to and incorporates by reference the entire contents of Japanese Patent Application No. 2025-020534 filed in Japan on Feb. 12, 2025.

### BACKGROUND OF THE INVENTION

### 1. Field of the Invention

The present invention relates to a terminal block.

### 2. Description of the Related Art

Conventionally, there is a structure including a bus bar and a magnetic body for removing noise. Japanese Patent Application Laid-open No. 2015-230947 discloses a bus bar holding structure in which a first-phase bus bar, a second-phase bus bar, and a third-phase bus bar are surrounded by a magnetic material.

When the packing is disposed between the bus bar and the housing that holds the bus bar, it is desirable that a decrease in sealing performance of the packing can be reduced. In this case, it is preferable that an increase in the number of components can be reduced.

### SUMMARY OF THE INVENTION

An object of the present invention is to provide a terminal block capable of reducing a decrease in water-stop performance of a packing while reducing an increase in the number of components.

A terminal block according to one aspect of the present invention includes a bus bar; a magnetic body unit including an annular magnetic body and a cover covering the magnetic body, the magnetic body unit being configured such that the bus bar can be inserted into the magnetic body; a packing mounted on the bus bar inserted into the magnetic body unit; and a housing including a through hole that holds the bus bar and the packing, and a cylindrical portion that accommodates the magnetic body unit, wherein the cover includes a support portion that supports the packing inserted into the through hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is a perspective view of the terminal block according to the embodiment;

FIG. 3 is a perspective view of a terminal block according to an embodiment;

FIG. 4 is a perspective view of the magnetic body according to the embodiment;

FIG. 5 is a perspective view of the magnetic body unit according to the embodiment;

FIG. 6 is a plan view of the magnetic body unit according to the embodiment;

FIG. 7 is a cross-sectional view of the magnetic body unit according to the embodiment;

FIG. 8 is a perspective view of a housing according to the embodiment;

FIG. 9 is a cross-sectional view of the housing according to the embodiment; and

FIG. 10 is a cross-sectional view of the terminal block according to the embodiment.

### DETAILED DESCRIPTION OF THE PREFERRED EMBODIMENTS

Hereinafter, a terminal block according to an embodiment of the present invention will be described in detail with reference to the drawings. Note that the present invention is not limited by this embodiment. In addition, constituent elements in the following embodiments include those that can be easily assumed by those skilled in the art or those that are substantially the same.

### Embodiment

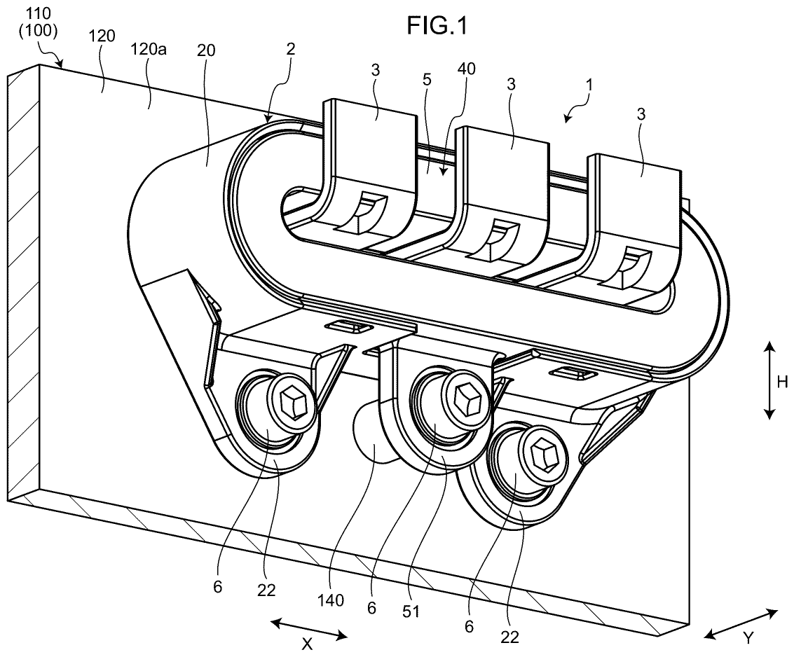

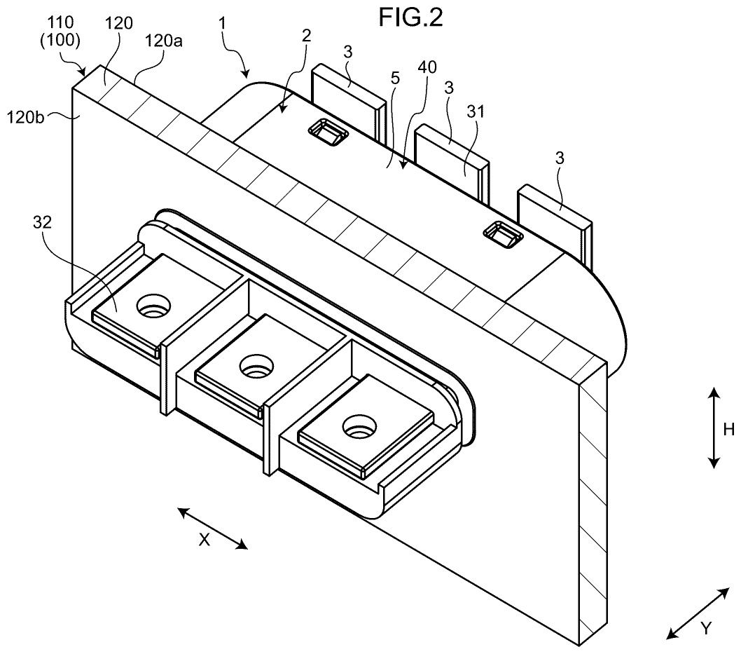

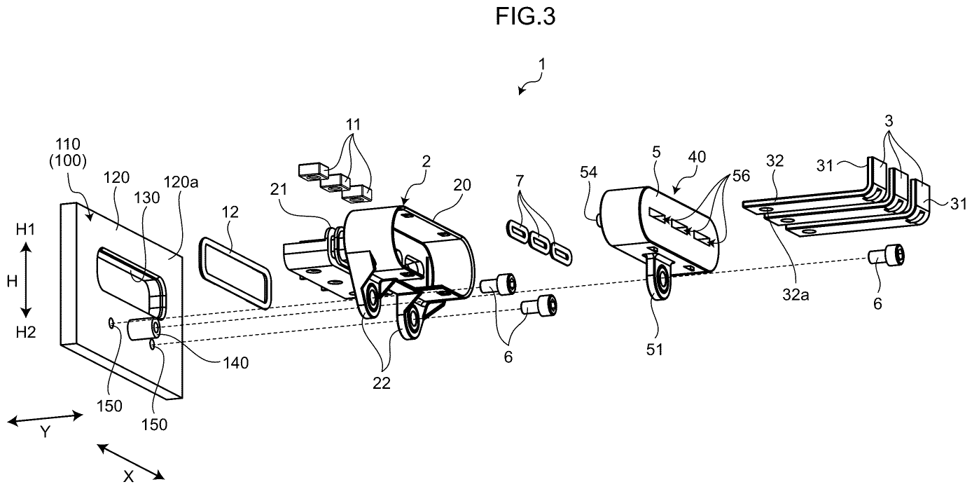

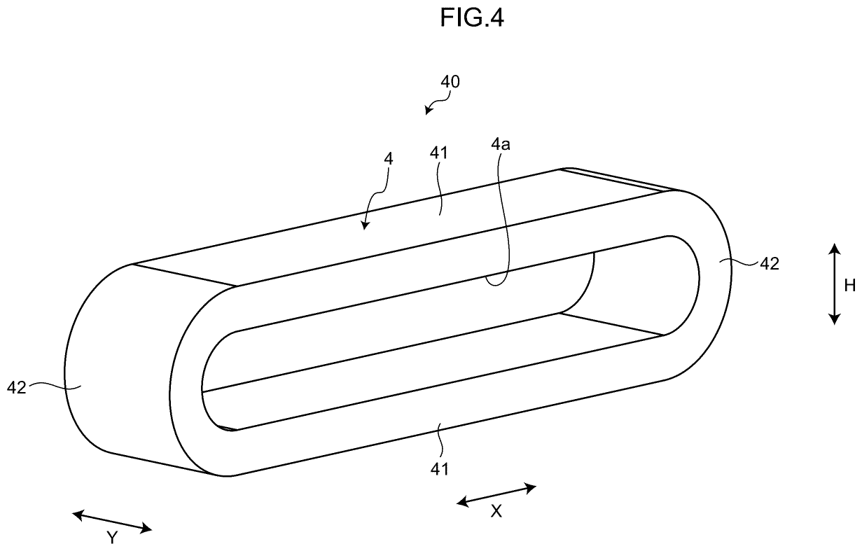

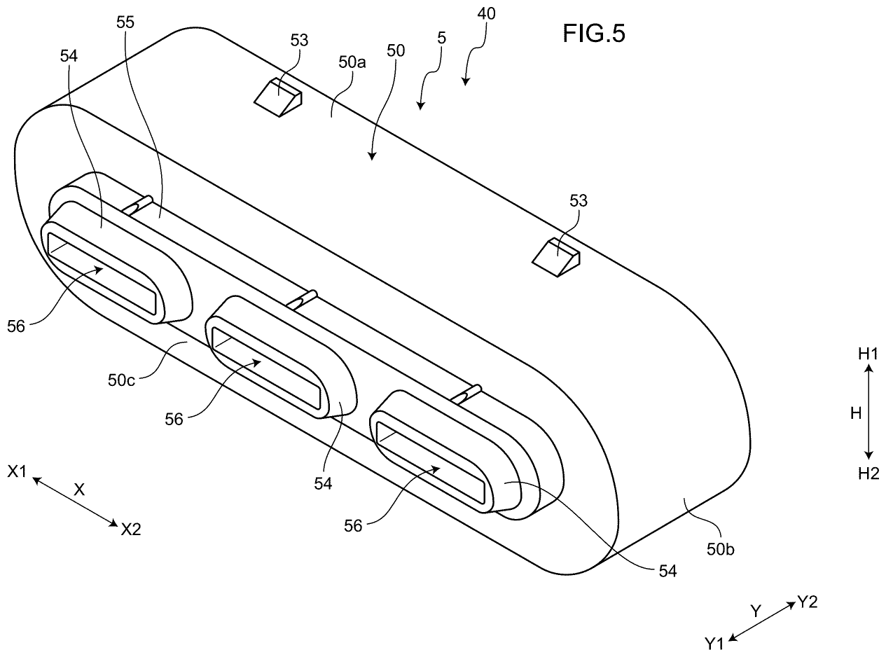

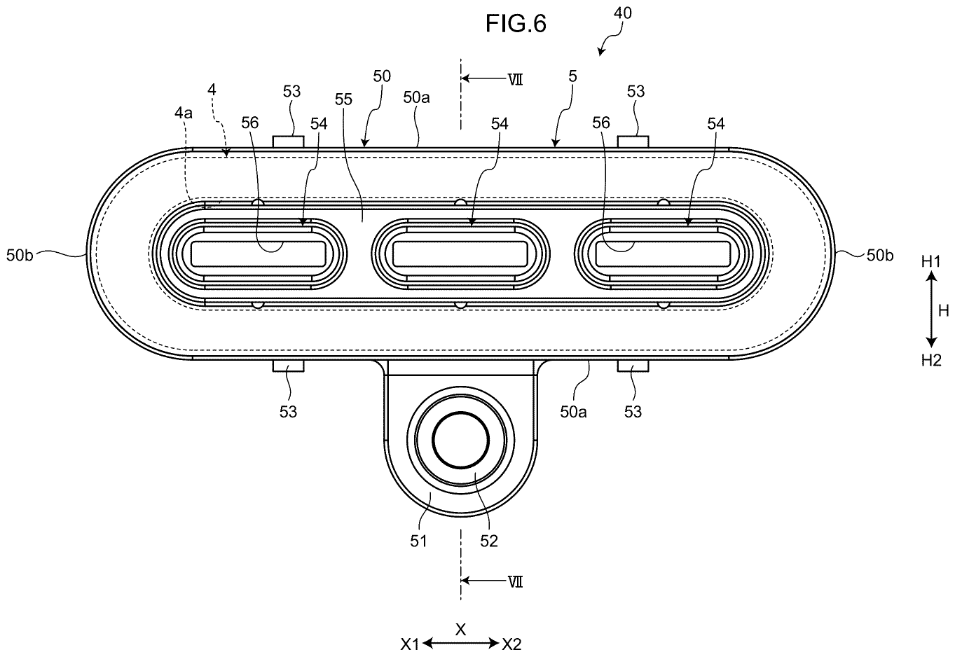

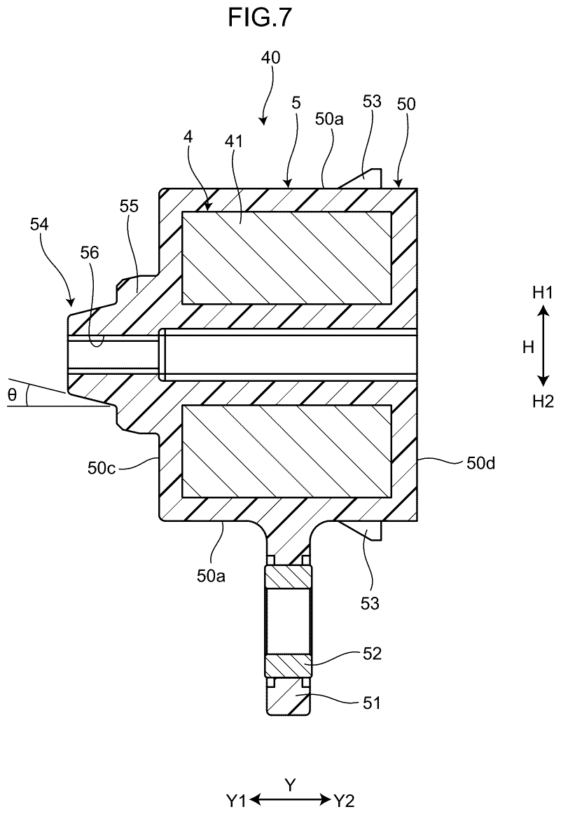

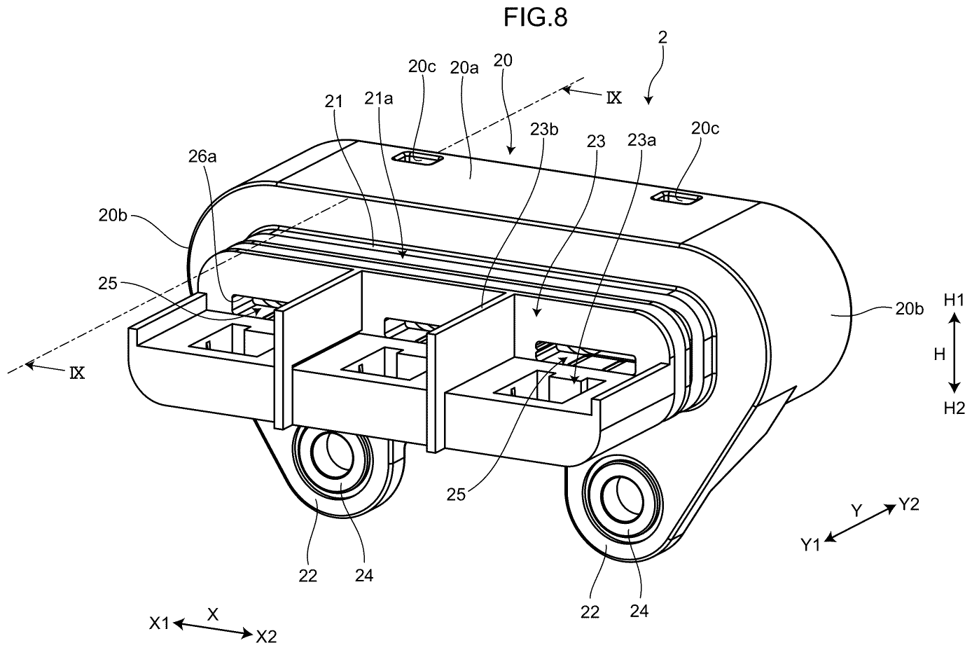

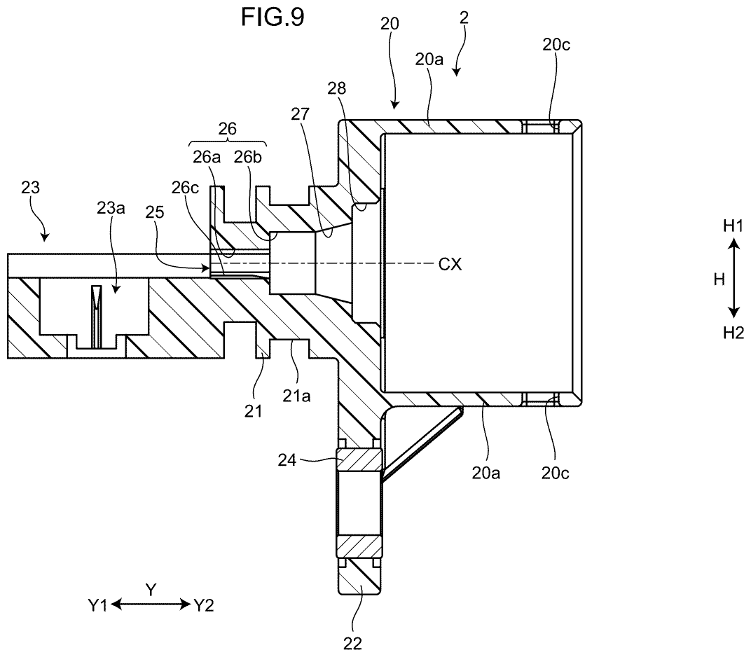

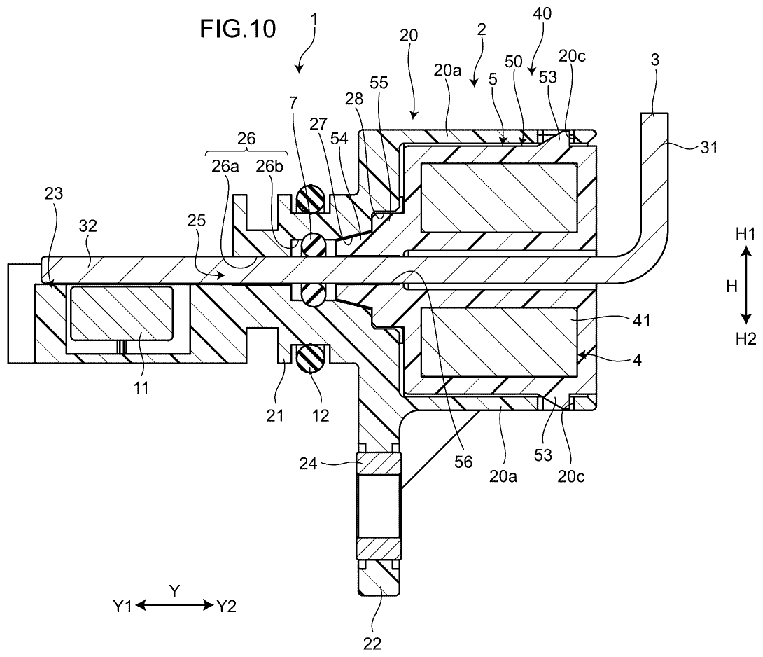

An embodiment will be described with reference to FIGS. 1 to 10. The present embodiment relates to a terminal block. FIGS. 1 and 2 are perspective views of a terminal block according to an embodiment, FIG. 3 is an exploded perspective view of the terminal block according to the embodiment, FIG. 4 is a perspective view of a magnetic body according to the embodiment, FIG. 5 is a perspective view of a magnetic body unit according to the embodiment, FIG. 6 is a plan view of the magnetic body unit according to the embodiment, FIG. 7 is a cross-sectional view of the magnetic body unit according to the embodiment, FIG. 8 is a perspective view of a housing according to the embodiment, FIG. 9 is a cross-sectional view of the housing according to the embodiment, and FIG. 10 is a cross-sectional view of the terminal block according to the embodiment. FIG. 7 illustrates a VII-VII cross section of FIG. 6. FIG. 9 illustrates a IX-IX cross section of FIG. 8.

As illustrated in FIG. 1, a terminal block 1 of the present embodiment is fixed to a case 110 of a device 100. The device 100 is, for example, a device mounted on a vehicle such as an automobile. The device 100 may be a motor. The case 110 of the device 100 includes a wall portion 120. The wall portion 120 is, for example, an outer wall of the case 110. The terminal block 1 is fixed to the wall portion 120 and supported by the wall portion 120. The case 110 has a width direction X, a depth direction Y, and a height direction H. The width direction X and the depth direction Y are orthogonal to each other. The height direction H is orthogonal to both the width direction X and the depth direction Y. The width direction X and the depth direction Y are, for example, a front-rear direction and a vehicle width direction of the vehicle. In this case, the height direction H is a vehicle vertical direction.

The illustrated wall portion 120 is orthogonal to the depth direction Y. The wall portion 120 includes a first wall surface 120a facing the outside of the case 110 and a second wall surface 120b facing the inside of the case 110. The first wall surface 120a is a surface along the width direction X and the height direction H, and is, for example, a flat surface. The terminal block 1 is fixed to the case 110 so as to be in contact with the first wall surface 120a of the wall portion 120.

As illustrated in FIG. 3, a through hole 130 is provided in the wall portion 120 of the case 110. The through hole 130 is opened in each of the first wall surface 120a and the second wall surface 120b. That is, the through hole 130 allows the space portion on one side and the space portion on the other side sandwiching the wall portion 120 to communicate with each other. When the wall portion 120 is the outer wall of the case 110, the through hole 130 allows the external space and the internal space of the case 110 to communicate with each other. The housing 2 includes a fitting portion 21 that fits into the through hole 130.

The wall portion 120 of the case 110 is provided with a first screw portion 140 and a second screw portion 150. The first screw portion 140 is a female screw portion corresponding to a first fixing portion 51 of a cover 5. The first screw portion 140 protrudes from the first wall surface 120a of the wall portion 120 along the depth direction Y. The illustrated first screw portion 140 has a cylindrical shape, and a screw thread is provided on the inner peripheral surface. The first fixing portion 51 is fixed to the distal end surface of the first screw portion 140 by a fastening member 6.

The second screw portion 150 is a screw portion corresponding to a second fixing portion 22 of the housing 2. The second screw portion 150 is recessed from the first wall surface 120a of the wall portion 120 along the depth direction Y. A screw thread is provided on the inner peripheral surface of the second screw portion 150. The case 110 of the present embodiment includes two second screw portions 150. The two second screw portions 150 are disposed on both sides in the width direction X with the first screw portion 140 interposed therebetween.

As illustrated in FIG. 3, the terminal block 1 includes the housing 2, the bus bar 3, a magnetic body unit 40, a plurality of fastening members 6, a packing 7, a nut 11, and an O-ring 12.

The housing 2 is a member that holds the bus bar 3 and the packing 7 and is fixed to the case 110. The housing 2 is molded using, for example, insulating synthetic resin. The housing 2 of the present embodiment is fixed to the case 110 in a state of accommodating and holding the magnetic body unit 40. The nut 11 is a fastening member that fixes the bus bar 3 to the terminal of the device 100, and is accommodated in the recess of the housing 2. The O-ring 12 is mounted to the fitting portion 21 of the housing 2. The O-ring 12 seals between the fitting portion 21 and the inner wall surface of the through hole 130 of the case 110.

The bus bar 3 is a plate-shaped conductive member, and is formed of a conductive metal plate such as copper. The bus bar 3 includes a first terminal portion 31 and a second terminal portion 32. The first terminal portion 31 is one end portion of the bus bar 3, and the second terminal portion 32 is the other end portion of the bus bar 3. The illustrated bus bar 3 is bent at a right angle between the first terminal portion 31 and the second terminal portion 32. A plate-like portion of the bus bar 3 including the second terminal portion 32 is inserted into the magnetic body unit 40 and the housing 2.

The first terminal portion 31 is connected to a power source side of a battery or the like of the vehicle. The first terminal portion 31 may be connected to the inverter. The second terminal portion 32 is connected to a terminal of the device 100. That is, the bus bar 3 of the present embodiment is interposed between the power supply and the device 100. The illustrated terminal block 1 has three bus bars 3. The second terminal portion 32 is provided with a through hole 32a into which a bolt can be inserted. The second terminal portion 32 is fastened to a terminal of the device 100 by a nut 11 and a bolt.

The packing 7 is a seal member mounted on the bus bar 3. The packing 7 seals between the bus bar 3 and the through hole of the housing 2. The packing 7 is mounted to the bus bar 3 inserted into the magnetic body unit 40. The bus bar 3 is inserted into the housing 2 with the side of the second terminal portion 32 as a head in a state where the packing 7 is attached.

The magnetic body unit 40 includes a magnetic body 4 illustrated in FIG. 4 and the cover 5 illustrated in FIGS. 5 to 7. The magnetic body 4 is formed of a magnetic body having a noise reduction function. The magnetic body 4 is formed of, for example, ferrite. As illustrated in FIG. 4, the magnetic body 4 includes a hole 4a through which the bus bar 3 can be inserted. The magnetic body 4 of the present embodiment is configured such that the three bus bars 3 can be inserted into one hole 4a. The illustrated magnetic body 4 has a cylindrical shape. More specifically, the cross-sectional shape of the magnetic body 4 in the cross section orthogonal to the axial direction of the hole 4a is an oval shape. In a state where the terminal block 1 is fixed to the case 110, the major axis direction of the cross section of the magnetic body 4 is along the width direction X, and the minor axis direction of the cross section is along the height direction H. The axial direction of the hole 4a is along the depth direction Y.

The magnetic body 4 includes a pair of flat plate portions 41 and a pair of arcuate portions 42. The pair of flat plate portions 41 has a flat plate shape and is parallel to each other. In a state where the terminal block 1 is fixed to the case 110, the pair of flat plate portions 41 faces each other in the height direction H. The arcuate portion 42 has an arcuate shape, and connects an end portion of one flat plate portion 41 and an end portion of another flat plate portion 41. In a state where the terminal block 1 is fixed to the case 110, the pair of arcuate portions 42 faces each other in the width direction X.

As illustrated in FIGS. 5 to 7, the cover 5 covers the magnetic body 4. The illustrated cover 5 covers the outer peripheral surface, the inner peripheral surface, and both end surfaces of the magnetic body 4. The cover 5 is molded using, for example, insulating synthetic resin. The cover 5 of the present embodiment is molded with respect to the magnetic body 4 and is integrated with the magnetic body 4. Therefore, the magnetic body 4 is sealed inside the cover 5.

The magnetic body 4 may be bonded to the cover 5 or press-fitted into the cover 5. In this case, the cover 5 preferably includes an accommodation chamber that accommodates the magnetic body 4. For example, the magnetic body 4 is bonded to the cover 5 in a state of being accommodated in the accommodation chamber of the cover 5, and is held by the cover 5. For example, the magnetic body 4 is press-fitted into an accommodation chamber of the cover 5 and held by the cover 5. The cover 5 may have a lid that closes the accommodation chamber and covers the magnetic body 4.

The cover 5 includes a main body 50 accommodating the magnetic body 4, the first fixing portion 51, a collar 52, an engagement portion 53, a support portion 54, and a raised portion 55. The main body 50, the first fixing portion 51, the engagement portion 53, the support portion 54, and the raised portion 55 are integrated. In the plan view of FIG. 6, the shape of the main body 50 is an oval shape.

The outer peripheral surface of the main body 50 includes a pair of planar portions 50a and a pair of arcuate portions 50b. The planar portion 50a is a flat surface located outside the flat plate portion 41 of the magnetic body 4. One planar portion 50a faces a first side H1 in the height direction H, and the other planar portion 50a faces a second side H2 in the height direction H.

The arcuate portion 50b is an arcuate curved surface located outside the arcuate portion 42 of the magnetic body 4. The arcuate portion 50b connects one planar portion 50a and the other planar portion 50a, and is curved toward the width direction X. One arcuate portion 50b is convex toward a first side X1 in the width direction X, and the other arcuate portion 50b is convex toward a second side X2 in the width direction X. The pair of planar portions 50a and the pair of arcuate portions 50b constitute an oval-shaped outer peripheral surface of the main body 50.

The first fixing portion 51 protrudes from the outer peripheral surface of the main body 50. More specifically, the first fixing portion 51 protrudes from one planar portion 50a of the main body 50. The first fixing portion 51 protrudes toward the side opposite to the side of the other planar portion 50a. The first fixing portion 51 includes a plate shape and holds the collar 52. The collar 52 may be integrated with the first fixing portion 51 by molding, or may be press-fitted into a hole of the first fixing portion 51. The first fixing portion 51 holds the collar 52 such that the axial direction of the collar 52 is along the depth direction Y.

The engagement portion 53 protrudes from the outer peripheral surface of the main body 50. More specifically, the engagement portion 53 protrudes from the planar portion 50a of the main body 50. The cover 5 of the present embodiment is provided with four engagement portions 53. Two engagement portions 53 are disposed on each of the pair of planar portions 50a. The two engagement portions 53 are disposed at both ends of the planar portion 50a in the width direction X. The engagement portion 53 disposed on the planar portion 50a on the first side H1 protrudes toward the first side H1, and the engagement portion 53 disposed on the planar portion 50a on the second side H2 protrudes toward the second side H2.

The support portion 54 is configured to be able to support the packing 7 mounted on the bus bar 3. The bus bar 3 is inserted into the magnetic body unit 40 so as to penetrate the support portion 54. As illustrated in FIG. 5, the support portion 54 protrudes from an end surface 50c of the main body 50 toward a first side Y1. The end surface 50c is one of two end surfaces of the main body 50 and faces the first side Y1 in the depth direction Y. The second terminal portion 32 of the bus bar 3 is inserted into the magnetic body unit 40 from a second side Y2 and protrudes toward the first side Y1.

The cover 5 includes a number of support portions 54 corresponding to the number of the bus bars 3. The illustrated cover 5 includes three support portions 54 arranged in the width direction X. The cover 5 includes a raised portion 55 common to the three support portions 54. The raised portion 55 is raised from the end surface 50c of the main body 50 toward the first side Y1. The three support portions 54 protrude from one raised portion 55.

As illustrated in FIG. 6, the shape of the raised portion 55 and the support portion 54 in plan view is an oval shape. The major axis direction of the raised portion 55 and the support portion 54 is the width direction X. The three support portions 54 are disposed in a region surrounded by the magnetic body 4 in plan view. That is, the support portion 54 is disposed so as to position the bus bar 3 inserted into the cover 5 in a region surrounded by the magnetic body 4.

As illustrated in FIG. 7, the shape of the support portion 54 in the cross section along the depth direction Y is a tapered shape. The support portion 54 becomes thinner toward the first side Y1 in the depth direction Y. For example, as illustrated in FIG. 7, the dimension of the support portion 54 in the height direction H decreases toward the first side Y1. Similarly, the dimension of the support portion 54 in the width direction X decreases toward the first side Y1. As illustrated in FIG. 7, in the cross section orthogonal to the width direction X, the wall surface of the support portion 54 is inclined with respect to the depth direction Y. The wall surface of the support portion 54 has an inclination angle θ with respect to the depth direction Y.

As illustrated in FIG. 7, the cover 5 includes a through hole 56. The through hole 56 penetrates the main body 50, the raised portion 55, and the support portion 54 along the depth direction Y. That is, the through hole 56 extends from the distal end surface of the support portion 54 to an end surface 50d on the second side Y2 of the main body 50. The cover 5 includes the number of through holes 56 corresponding to the number of the bus bars 3. In other words, the through hole 56 is formed for each support portion 54. The cross-sectional shape of the through hole 56 is determined such that the bus bar 3 can be inserted into the through hole 56 and the packing 7 cannot pass therethrough. The cross-sectional shape of the through hole 56 is, for example, a rectangle having a long side along the width direction X. As illustrated in FIG. 6, the three through holes 56 are disposed in a region surrounded by the magnetic body 4 and are aligned in the width direction X.

As illustrated in FIG. 8, the housing 2 includes a cylindrical portion 20, a fitting portion 21, the second fixing portion 22, a support portion 23, and a collar 24. The cylindrical portion 20, the fitting portion 21, the second fixing portion 22, and the support portion 23 are integrated. The cylindrical portion 20 is a portion that accommodates the magnetic body unit 40 and has a cylindrical shape corresponding to the shape of the magnetic body unit 40. The shape of the cylindrical portion 20 in plan view is an oval shape. The cylindrical portion 20 includes a pair of straight portions 20a and a pair of arcuate portions 20b. The straight portion 20a is a portion covering the planar portion 50a of the cover 5 and has a flat plate shape. The arcuate portion 20b is a portion covering the arcuate portion 50b of the cover 5 and has an arcuate plate shape.

As illustrated in FIG. 8, the straight portion 20a of the cylindrical portion 20 is provided with a hole 20c corresponding to the engagement portion 53 of the cover 5. The hole 20c is a through hole penetrating the straight portion 20a in the height direction H. The hole 20c is disposed in each of the pair of straight portions 20a. One straight portion 20a is provided with two holes 20c. The two holes 20c are disposed at both ends of the straight portion 20a in the width direction X.

The fitting portion 21 is a portion fitted into the through hole 130 of the case 110. The fitting portion 21 protrudes from the cylindrical portion 20 in the depth direction Y. The shape of the fitting portion 21 is a tubular shape or a rectangular parallelepiped shape having a substantially rectangular cross-sectional shape. An annular recess 21a to which the O-ring 12 is mounted is provided on an outer peripheral surface of the fitting portion 21.

The support portion 23 is a portion that supports the nut 11. As illustrated in FIG. 8, the support portion 23 protrudes from the fitting portion 21 in the depth direction Y. The support portion 23 includes a plurality of recesses 23a and a plurality of partition walls 23b. The recess 23a accommodates the nut 11 and holds the nut 11. The recess 23a is open toward the first side H1 in the height direction H. The recess 23a holds the nut 11 such that the central axis of the nut 11 is along the height direction H.

The support portion 23 includes the number of recesses 23a corresponding to the number of the bus bars 3. The housing 2 of the present embodiment includes three recesses 23a arranged in the width direction X. The partition wall 23b partitions between two adjacent recesses 23a. The partition wall 23b extends along the depth direction Y so as to partition the plurality of bus bars 3 protruding from the fitting portion 21.

The second fixing portion 22 protrudes from a boundary portion between the cylindrical portion 20 and the fitting portion 21. The second fixing portion 22 protrudes from one straight portion 20a of the cylindrical portion 20 toward the side opposite to the side of the other straight portion 20a. The second fixing portion 22 includes a plate shape and holds the collar 24. The collar 24 may be integrated with the second fixing portion 22 by molding, or may be press-fitted into a hole of the second fixing portion 22. The second fixing portion 22 holds the collar 24 such that the axial direction of the collar 24 is along the depth direction Y.

As illustrated in FIGS. 8 and 9, the housing 2 includes a through hole 25 for holding the bus bar 3 and the packing 7. The through hole 25 penetrates the fitting portion 21 along the depth direction Y. The through hole 25 opens toward the support portion 23 on the first side Y1 in the depth direction Y and opens toward the internal space of the cylindrical portion 20 on the second side Y2. The housing 2 includes the number of through holes 25 corresponding to the number of the bus bars 3. The illustrated housing 2 includes three through holes 25 arranged in the width direction X.

As illustrated in FIG. 9, the through hole 25 includes a holding portion 26 and an accommodation portion 27. Further, a recess 28 connected to the accommodation portion 27 is formed in the cylindrical portion 20. The holding portion 26 holds the bus bar 3 and the packing 7. The accommodation portion 27 accommodates the support portion 54 of the magnetic body unit 40. The recess 28 is fitted to the raised portion 55 of the magnetic body unit 40.

The holding portion 26 includes a first holding portion 26a and a second holding portion 26b. The first holding portion 26a is formed so as to be able to hold the bus bar 3. The first holding portion 26a is an end portion of the through hole 25 on the first side Y1 and opens toward the support portion 23. As illustrated in FIG. 8, a cross-sectional shape of the first holding portion 26a is rectangular. The shape of the first holding portion 26a is determined such that the bus bar 3 can be inserted into the first holding portion 26a and the packing 7 cannot enter the first holding portion 26a. The first holding portion 26a is provided with a rib 26c for holding the bus bar 3. The rib 26c is, for example, a rib extending in the depth direction Y. The rib 26c may be a crushing rib.

The second holding portion 26b is formed so as to be able to hold the packing 7. A cross-sectional area of the second holding portion 26b is larger than a cross-sectional area of first holding portion 26a. The second holding portion 26b is located on the second side Y2 with respect to the first holding portion 26a and is continuous with the first holding portion 26a. A step is provided between the first holding portion 26a and the second holding portion 26b so as to be able to lock the packing 7. The cross-sectional shape of the second holding portion 26b is an oval shape. The packing 7 seals between the wall surface of the second holding portion 26b and the bus bar 3.

The accommodation portion 27 is formed so as to be able to accommodate at least a part of the support portion 54 of the cover 5. The accommodation portion 27 is located on the second side Y2 with respect to the second holding portion 26b and is continuous with the second holding portion 26b. The accommodation portion 27 is an end portion of the through hole 25 on the second side Y2 and opens toward the internal space of the cylindrical portion 20. The cross-sectional shape of the accommodation portion 27 is an oval shape.

The accommodation portion 27 includes a tapered shape along the depth direction Y. More specifically, the cross-sectional area of the accommodation portion 27 decreases toward the second holding portion 26b along the depth direction Y. The wall surface surrounding the accommodation portion 27 is inclined so as to approach the central axis CX of the through hole 25 toward the second holding portion 26b along the depth direction Y. The inclination angle of the wall surface corresponds to an inclination angle θ of the support portion 54.

The recess 28 is formed so as to be fitted with the raised portion 55 of the cover 5 and capable of accommodating at least a part of the raised portion 55. In the recess 28, a wall surface facing the central axis CX is formed so as to surround the three accommodation portions 27. In other words, the three accommodation portions 27 communicate with one recess 28. The shape of the recess 28 in plan view is an oval shape that is long in the width direction X.

FIG. 10 illustrates a state in which the bus bar 3, the packing 7, and the magnetic body unit 40 are assembled to the housing 2. The second terminal portion 32 of the bus bar 3 is inserted into the through hole 56 of the magnetic body unit 40 and protrudes from the through hole 56 toward the first side Y1. The packing 7 is mounted on the bus bar 3 protruding from the through hole 56. That is, the second terminal portion 32 protruding from the magnetic body unit 40 is inserted into the packing 7. The mounting position of the packing 7 is a position between the second terminal portion 32 and the support portion 54.

The bus bar 3 on which the packing 7 is mounted is inserted into the through hole 25 of the housing 2 with the second terminal portion 32 as a head. The second terminal portion 32 protrudes from the through hole 25 and faces the nut 11 in the height direction H. The bus bar 3 is held by the first holding portion 26a of the through hole 25.

The packing 7 is inserted into the second holding portion 26b of the through hole 25 and held by the second holding portion 26b. The support portion 54 of the cover 5 supports the packing 7 from the second side Y2, and can push the packing 7 into the second holding portion 26b.

The magnetic body unit 40 is accommodated in the cylindrical portion 20 of the housing 2. When the magnetic body unit 40 is accommodated in the cylindrical portion 20, the engagement portion 53 of the cover 5 is engaged with the hole 20c of the housing 2. As a result, the magnetic body unit 40 is temporarily locked to the housing 2. In the present specification, a state in which the engagement portion 53 of the magnetic body unit 40 is locked by the hole 20c of the housing 2 is referred to as a temporary locked state.

In the terminal block 1 of the present embodiment, the entire magnetic body 4 is accommodated in the internal space of the cylindrical portion 20 in the temporary locked state illustrated in FIG. 10. The entire main body 50 of the cover 5 is accommodated in the internal space of the cylindrical portion 20.

In the temporary locked state, the support portion 54 of the cover 5 is inserted into the accommodation portion 27 of the through hole 25 and accommodated in the accommodation portion 27. The support portion 54 is configured to be able to push the packing 7 into the second holding portion 26b until the magnetic body unit 40 is inserted into the position in the temporary locked state. The gap between the outer peripheral surface of the support portion 54 and the wall surface of the accommodation portion 27 is set to be smaller than the thickness of the packing 7. In addition, the distal end surface of the support portion 54 is flat and has a sufficient width to appropriately support the packing 7. The distal end surface of the support portion 54 functions as a support surface that supports the packing 7, and presses the packing 7 toward the first side Y1.

The wall surface of the accommodation portion 27 is inclined so as to be able to guide the packing 7 to the second holding portion 26b. Therefore, the support portion 54 can slide the packing 7 toward the second holding portion 26b along the wall surface of the accommodation portion 27, and can push the packing 7 into the second holding portion 26b.

In the temporary locked state, the distal end surface of the support portion 54 enters the second holding portion 26b. Therefore, the support portion 54 can accommodate the entire packing 7 inside the second holding portion 26b. In addition, the distal end surface of the support portion 54 can close the end portion of the second holding portion 26b to regulate the packing 7 from coming off from the second holding portion 26b.

The raised portion 55 of the cover 5 is fitted into the recess 28 of the housing 2. The recess 28 accommodates the raised portion 55, and can reduce positional deviation and inclination of the magnetic body unit 40. The major axis direction of the recess 28 having an oval shape is the width direction X. Therefore, the recess 28 can reduce the inclination of the magnetic body unit 40 with respect to the width direction X. Since the positional deviation and inclination of the magnetic body unit 40 are reduced, variations in water-blocking performance of the three packings 7 are reduced.

The engagement portion 53 of the cover 5 is engaged with the hole 20c of the housing 2 and is locked by the hole 20c. The hole 20c locks the engagement portion 53 at least in the depth direction Y, and regulates the magnetic body unit 40 and the packing 7 from falling off from the housing 2. In the temporary locked state of FIG. 10, the hole 20c temporarily locks the magnetic body unit 40, and the magnetic body unit 40 can be positioned with respect to the housing 2.

The terminal block 1 illustrated in FIG. 10 is assembled to the case 110 of the device 100. The support portion 23 of the terminal block 1 is inserted into the through hole 130 of the case 110, and the fitting portion 21 is fitted into the through hole 130. As illustrated in FIG. 1, the first fixing portion 51 of the magnetic body unit 40 is fixed to the first screw portion 140 of the case 110 by the fastening member 6. Each of the two second fixing portions 22 of the housing 2 is fixed to the case 110 by the fastening member 6.

Since both the housing 2 and the magnetic body unit 40 are fixed to the case 110, relative movement between the housing 2 and the magnetic body unit 40 is regulated. Therefore, the support portion 54 of the magnetic body unit 40 can appropriately support the packing 7. As illustrated in FIG. 10, the support portion 54 is inserted into the accommodation portion 27 which is an inlet portion of the through hole 25 to close the through hole 25. The support portion 54 closes the through hole 25 from the second side Y2 to support the packing 7.

When the device 100 side has a high pressure with respect to the packing 7, a pressing force toward the second side Y2 acts on the packing 7. At this time, the support portion 54 supports the packing 7 from the second side Y2, and a decrease in sealing performance due to the packing 7 can be reduced. Since the magnetic body unit 40 is directly fixed to the case 110, the support portion 54 can appropriately support the packing 7 against the pressure received from the device 100 side. Further, since the support portion 54 closes the through hole 25, the pressure difference on both sides of the packing 7 is alleviated. Therefore, the terminal block 1 of the present embodiment can reduce a decrease in sealing performance due to the packing 7.

As described above, the terminal block 1 of the present embodiment includes the bus bar 3, the magnetic body unit 40, the packing 7, and the housing 2. The magnetic body unit 40 includes the annular magnetic body 4 and the cover 5 that covers the magnetic body 4. The magnetic body unit 40 is configured such that the bus bar 3 can be inserted into the magnetic body 4. The packing 7 is mounted to the bus bar 3 inserted into the magnetic body unit 40. The housing 2 includes the through hole 25 that holds the bus bar 3 and the packing 7, and the cylindrical portion 20 that accommodates the magnetic body unit 40. The cover 5 includes the support portion 54 that supports the packing 7 inserted into the through hole 25. According to the terminal block 1 of the present embodiment, deterioration in sealing performance of the packing 7 can be reduced with a simple configuration.

The housing 2 of the present embodiment includes the hole 20c. The hole 20c is an example of a locking portion that locks the cover 5 accommodated in the cylindrical portion 20. The hole 20c locks the cover 5 in a state where the support portion 54 is inserted into the through hole 25 and the through hole 25 is closed. With such a configuration, the support portion 54 can appropriately support the packing 7.

The through hole 25 of the present embodiment includes an inlet portion into which the bus bar 3 and the packing 7 are inserted. The inlet portion of the through hole 25 is the accommodation portion 27 that opens toward the internal space of the cylindrical portion 20. The hole 20c as the locking portion locks the cover 5 in a state where the support portion 54 enters the accommodation portion 27. Since the support portion 54 enters the accommodation portion 27 and closes the through hole 25, the protrusion of the packing 7 from the through hole 25 and the like are appropriately reduced.

The cover 5 of the present embodiment includes the first fixing portion 51 fixed to the case 110 of the device 100. The housing 2 has a second fixing portion 22 fixed to the case 110. When the cover 5 is directly fixed to the case 110, the support portion 54 can appropriately support the packing 7.

The contents disclosed in the above embodiments can be appropriately combined and executed.

A terminal block according to the present embodiment includes a bus bar, a magnetic body unit including an annular magnetic body and a cover covering the magnetic body, the magnetic body unit being configured such that the bus bar can be inserted into the magnetic body; a packing mounted on the bus bar inserted into the magnetic body unit; and a housing including a through hole that holds the bus bar and the packing, and a cylindrical portion that accommodates the magnetic body unit. The cover has a support portion that supports the packing inserted into the through hole. According to the terminal block of the present embodiment, it is possible to reduce a decrease in water-stop performance of a packing while reducing an increase in the number of components.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar;
a magnetic body unit including an annular magnetic body and a cover covering the magnetic body, the magnetic body unit being configured such that the bus bar can be inserted into the magnetic body;
a packing mounted on the bus bar inserted into the magnetic body unit; and
a housing including a through hole that holds the bus bar and the packing, and a cylindrical portion that accommodates the magnetic body unit, wherein
the cover includes a support portion that supports the packing inserted into the through hole.

2. The terminal block according to claim 1, wherein
the housing includes a locking portion that locks the cover accommodated in the cylindrical portion, and
the locking portion locks the cover in a state where the support portion is inserted into the through hole and the through hole is closed.

3. The terminal block according to claim 2, wherein
the through hole includes an inlet portion into which the bus bar and the packing are inserted, and
the locking portion locks the cover in a state where the support portion enters the inlet portion.

4. The terminal block according to claim 1, wherein
the cover includes a first fixing portion fixed to a case of a device, and
the housing includes a second fixing portion fixed to the case.
